(19) United States
(12) Patent Application Publication
(10) Pub. No.: US 2002/0095597 A1
(43) Pub. Date: Jul. 18, 2002

(54) Reusable solutions for aircraft servicing

(76) Inventors: Gregory L. Norden, San Francisco, CA (US); Mark A. Steele, Lynwood, WA (US)

Correspondence Address: HARNESS, DICKEY & PIERCE, P.L.C., P.O. BOX 828, BLOOMFIELD HILLS, MI, 48303, US

(21) Appl. No.: 09/942,082

(22) Filed: Aug. 29, 2001

Related U.S. Application Data
(60) Provisional application No. 60/261,268, filed on Jan. 13, 2001.

(51) Int. Cl. H04L 9/32

(52) U.S. Cl. 713/200

(57) ABSTRACT

A system and method for servicing an aircraft provide increased efficiency and reliability. The method includes the step of providing a knowledge base of reusable solutions for the aircraft. An incoming message is received, where the incoming message characterizes a technical issue relating to the aircraft. The method further provides for generating an outgoing message in accordance with one or more of the reusable solutions in the knowledge base in response to the incoming message such that the outgoing address the technical issue.

### CROSS-REFERENCE TO RELATED APPLICATIONS

This application is claims priority to a provisional application, Serial No. 60/261,268, filed on Jan. 13, 2001.

### BACKGROUND OF THE INVENTION

1. Technical Field

The present invention generally relates to the servicing of commercial and military aircraft. More particularly, the invention relates to a computer-implemented method for servicing an aircraft that uses a knowledge base of reusable solutions to address technical issues with the aircraft.

2. Discussion

In the aircraft industry, manufacturing, servicing and flight operation are all important aspects in the life span of a modern day aircraft. More importantly, the cost, profitability and safety of an aircraft is often heavily dependent upon the extent to which these functions are integrated with one another. For example, a typical aircraft manufacturing enterprise is quite complex and requires vast amounts of engineering, skill and knowledge to manage the millions of parts, components and assemblies making up a typical aircraft. Once the aircraft is delivered to the airline (or aircraft operator enterprise), issues relating to the operation of the aircraft must also be addressed. While the operator enterprise commonly employs its own engineering and technical personnel (and often contracts with a maintenance provider enterprise), the sheer complexity of an aircraft often requires close interaction between operator representatives and manufacturer representatives in order to find acceptable solutions.

It is important to note that successful interaction between enterprises in the aircraft industry is particularly crucial considering the exacting requirements for safe operation of each aircraft. The conventional approach to servicing an aircraft fleet involves interacting over the phone or by an electronic message service. To save time and to ensure consistent results, an aircraft manufacturer representative, often called a service engineer, when faced with a particular service/maintenance question, will typically review prior correspondence to search for a similar problem.

Although requests and responses to fleet issues are generally kept in an electronic communication system in the form of sent and received messages, it is difficult to retrieve the data and experiences from the communication system for repetitive use. This difficulty is largely due to the complexity of modern aircraft. For example, a search for prior correspondences addressing the technical issue of bore corrosion might return hundreds or thousands of electronic messages containing the terms, while only one of the messages would actually detail the process for repairing bore corrosion. As a result, the solution often remains uncovered and data in the form of correspondence is continually recreated in support of fleet requests. Also, certain experienced individuals and technical groups commonly retain unreported support data using labor intensive and inconsistent methods. The usefulness or knowledge of this data is frequently lost following personnel changes.

As such, the airlines and maintenance providers come to aircraft manufacturers repetitively for support on issues that have been addressed in the past. To further complicate matters, the airlines are currently requiring more support information to be directly available and easily found at the moment it is needed.

Thus, many types of valuable commercial airplane technical support data are not effectively retained for later use. Support data that is currently retained and repetitively used is not stored in an efficient manner. This data is difficult to retrieve, share internally and share externally. As a result, information and experience is not effectively available for later use, and needs to be repetitively recreated. Additionally, information and experience is often lost following personnel changes.

Simply put, the existing methods tend to be labor intensive and inefficient. Improvements through the use of new electronic tools are needed for retaining knowledge and experience over the long term. It is therefore desirable to effectively provide direct technical support data to airlines and maintenance providers in a manner that enables these enterprises to solve their own problems whenever possible.

### SUMMARY OF THE INVENTION

The above and other objectives are provided by a system and method for servicing an aircraft in accordance with the principles of the present invention. The method includes the step of providing a knowledge base of reusable solutions for the aircraft. An incoming message is received, where the incoming message characterizes a technical issue relating to the aircraft. The method further provides for generating an outgoing message in accordance with one or more of the reusable solutions in the knowledge base in response to the incoming message such that the outgoing message addresses the technical issue. Thus, the method can be completely automated and provides a level of “self-help” that is unique to the aircraft industry.

Further in accordance with the present invention, a computer-implemented method for updating an aircraft-specific knowledge base is provided. The method includes the step of determining whether any reusable solutions of a knowledge base addresses a technical issue regarding an aircraft. The method further provides for verifying whether an individual has authoring access to the knowledge base. Authoring input is received from the individual when none of the reusable solutions addresses the technical issue. A new reusable solution is generated based on the authoring input when the individual has authoring access.

In another aspect of the invention, a computer-implemented aircraft servicing system includes a knowledge base of reusable solutions, a distributed tool and a security model. The knowledge base is derived from prior communications regarding an aircraft. The distributed tool maintains the knowledge base in accordance with characterizations of technical issues from individuals in a manufacturer enterprise, where the aircraft is manufactured by the manufacturer enterprise. The security model selectively allocates read and write access to the knowledge base between the individuals in the manufacturer enterprise and individuals in an operator enterprise, where the aircraft is operated by the operator enterprise.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute part of this specification. The drawings illustrate various features and embodiments of the invention, and together with the description serve to explain the principles and operation of the invention.

### BRIEF DESCRIPTION OF THE DRAWINGS

The various advantages of the present invention will become apparent to one skilled in the art by reading the following specification and sub-joined claims and by referencing the following drawings, in which:

FIG. 1 is a flow chart of a computer-implemented method for servicing an aircraft in accordance with the principles of the present invention;

FIG. 2 is a flow chart of a process for locating a reusable solution in accordance with the principles of the present invention;

FIG. 3 is a flow chart of a process for constructing an outgoing message in accordance with the principles of the present invention;

FIG. 4 is an illustration of a plurality of search roles in accordance with the principles of the present invention;

FIG. 5 is an illustration of a plurality of solution roles in accordance with the principles of the present invention;

FIG. 6 is a screen display of a home page of a reusable solution tool of the present invention;

FIG. 7 is a screen display allowing access to a service engineering tool or a Field Service and Customer Tool;

FIG. 8 illustrates a diagram of a work flow process used by the reusable solution tool;

FIG. 9 illustrates a quick reference guide to solution content standards;

FIG. 10 is a screen display of a user interface in one embodiment of the present invention;

FIG. 11 is a screen display of a response to a user inquiry of a first embodiment;

FIG. 12 is a screen display of a user interface in a second embodiment;

FIG. 13 is a screen display allowing a user to view solutions sorted by relevance;

FIGS. 14A and 14B are typical electronic correspondence by a service provider;

FIG. 15 is a screen display allowing user to refine a problem;

FIG. 16 is a screen display of a response to a user inquiry in a second embodiment; and

FIGS. 17A-17E show the process of using the reusable solution tool according to an embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

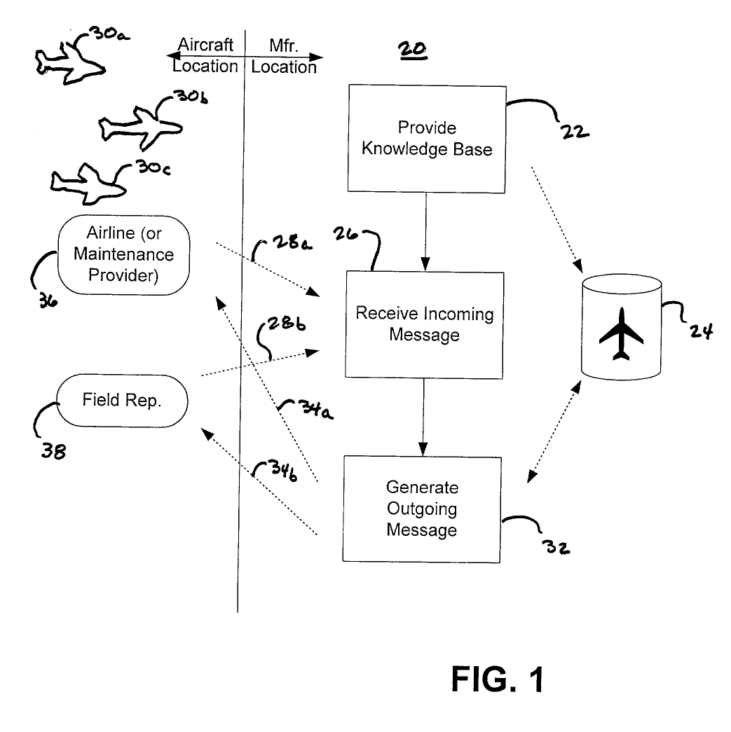

Turning now to FIG. 1, a computer-implemented method 20 for servicing an aircraft is shown. Generally, the method 20 includes the step 22 of providing a knowledge base 24 of reusable solutions for the aircraft. At step 26 an incoming message 28 is received, where the incoming message 28 characterizes a technical issue relating to the aircraft 30. It should be noted that the technical issue can be relevant to the fleet of aircraft 30, any individual aircraft 30a, 30b, 30c, or any combination thereof. It is also important to note that due to the complexity of modern day aircraft, the knowledge base 24 provides reusable solutions for more than two million parts of the aircraft 30. Indeed, the aircraft industry presents barriers to traditional servicing concepts that are unparalleled.

An outgoing message 34 is generated at step 32 in accordance with one or more of the reusable solutions in the knowledge base 24 in response to the incoming message 28 such that the outgoing message 34 addresses the technical issue. It will be appreciated that by generating the outgoing message 34 based on the knowledge base 24, the efficiency and cost related difficulties associated with conventional servicing approaches can be avoided. Furthermore, when the knowledge base 24 contains a pre-existing reusable solution that is relevant to the technical issue, the method 20 can be fully automated such that an airline (or maintenance provider) 36 or field representative 38 can readily find solutions without assistance from aircraft manufacturer service engineers.

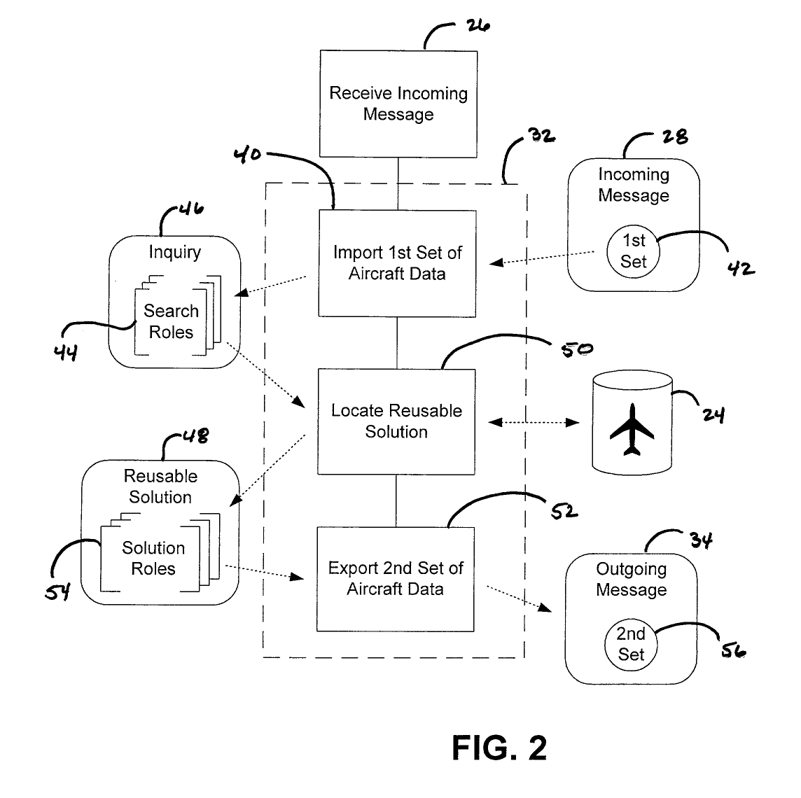

FIG. 2 illustrates the preferred approach to generating the outgoing message 34 at step 32. Specifically, it can be seen that step 40 provides for importing a first set of aircraft data 42 from the incoming message 28 into one or more search roles 44 of an inquiry 46. A relevant reusable solution 48 is located in accordance with the inquiry 46 at step 50. It can further be seen that step 52 provides for exporting data from one or more solution roles 54 of the relevant reusable solution 48 into a second set of aircraft data 56 in the outgoing message 34. The search roles 44 and solution roles 54 will be described in greater detail below.

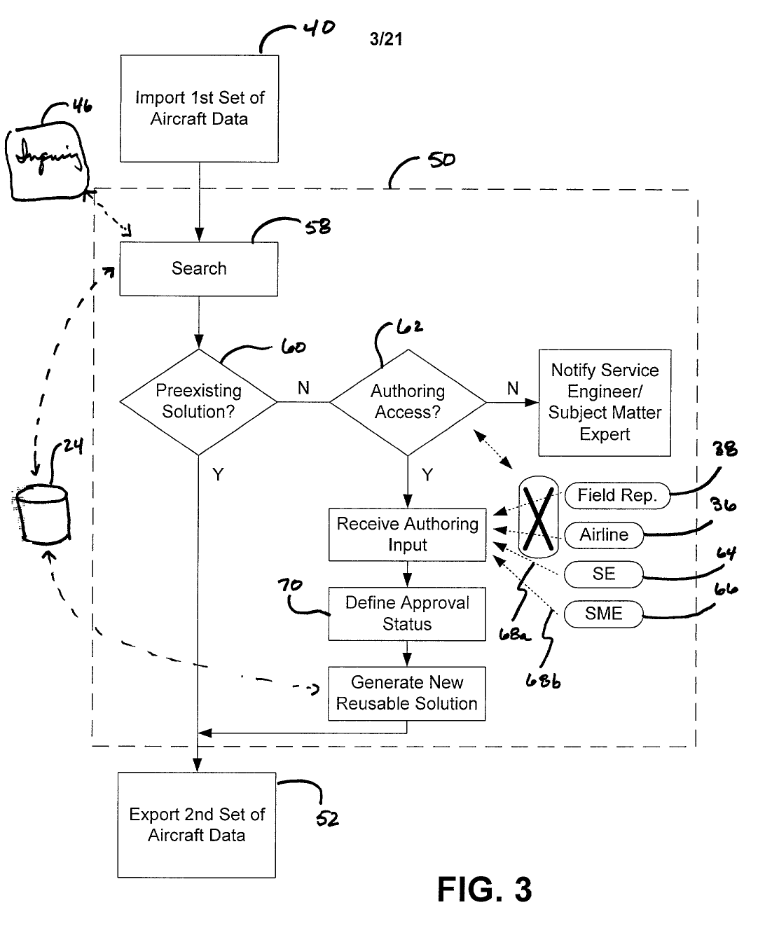

Turning now to FIG. 3, the preferred approach to locating a relevant reusable solution is shown in greater detail at step 50. Specifically, step 58 provides for searching the knowledge base 24 in accordance with the inquiry 46. It is determined whether any of the reusable solutions in the knowledge base 24 addresses the technical issue at step 60. In the event that none of the reusable solutions addresses the technical issue, step 62 provides for verifying that an individual has authoring access to the knowledge base 24. Thus, while field representatives 38, airlines 36, service engineers (SEs) 64 and subject matter experts (SMEs) 66 may all interact with the present invention to obtain solutions to aircraft-related problems (subject to approval status, as described below) authoring access may be limited. For example, when security input 68A is received from an SE 64 of a manufacturer of the aircraft, authoring access is granted. The same is true for an SME 66 providing security input 68B. This is because the SE 64 and the SME 66 are knowledgeable individuals within the aircraft manufacturer enterprise. On the other hand, a field representative 38, although typically also employed by the aircraft manufacturer enterprise, may not possess the level of engineering knowledge necessary to create reusable solutions. The same is often true for the airline 36 and other customers of the aircraft manufacturer enterprise. Thus, authoring access can be denied via the execution of step 62.

As mentioned above, it is preferred that an approval status is defined at step 70 for the new reusable solution, wherein the approval status enables access to the new reusable solution to be limited to a predefined group of individuals. For example, the new reusable solution can be assigned SE approval status or SME approval status. The SE approval status allows access to service engineers only. This approval status is used when the new reusable solution is of benefit for future use, but requires a review prior to use in correspondences sent to organizations outside of service engineering. The information is also used for internal data vendor information. Service engineering has access to all solutions in the database at any approval and status. Changing the status of the solution from “Draft” to “Approved” for Service Engineering confirms that an SE 64 has reviewed the solution for correct technical content. A new reusable solution is typically a candidate for SE approval status when the solution:

Has operator sensitive material or data;

Has service provider or supplier design information or test data;

Is an operator-specific problem;

Has warranty implications;

Has legal implications;

Has certification implications; or

Requires customization for specific airlines or other customers.

The SME approval status is used when the solution is of benefit for future use, but requires a review of the SME prior to the release of the information to other groups within service engineering. This status is also used for internal group data, which is of no use to other service engineering groups and might be annoying for other groups to find in a search. Most solutions will not require this level of security, but portions of the solution could be maintained at this approval level to maintain the confidentiality of sensitive information. A new reusable solution is typically a candidate for SME approval status when the solution:

Has very confidential service provider or supplier design information or test data;

Has legal implications that may involve specific individuals;

Is internal group specific data that is of no use for other groups; or

Requires an SME 66 to determine applicability.

In other words, certain data may be directly accessed by an aircraft operator while other data might be withheld because expert guidance is required to correctly interpret the data.

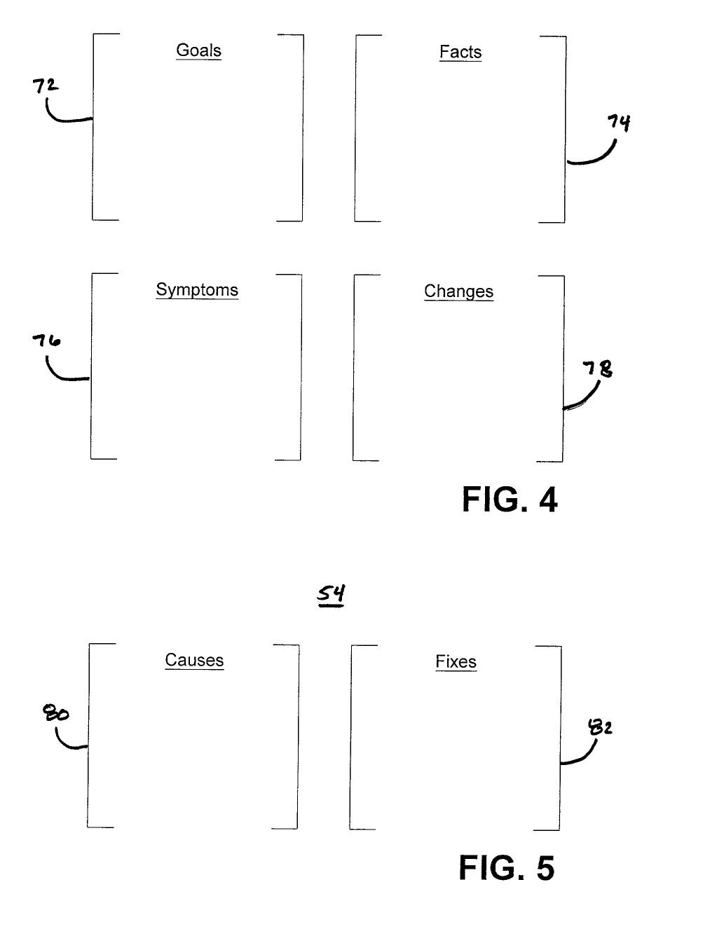

With regard to the inquiry of the aircraft-specific knowledge base, it can be seen that FIGS. 4 and 5 illustrate the preferred search roles 44 and solution roles 54, respectively in greater detail. It will be appreciated that generally, a search engine is used to find information in the aircraft-specific knowledge base. A general understanding of associative reasoning is needed to develop effective search criteria. Associative reasoning narrows the possibilities as more information is made available. This approach is in contrast to a key word approach, which expands the number of possibilities as more information is made available.

Specifically, there are six types of roles that make up a solution: goal, fact, symptom, change, cause, and fix. Only the goal, fact, symptom, and change roles are used for the purpose of search criteria. The algorithm places higher priority during the search on some of the roles. The program places more emphasis on goals, symptoms and causes. Facts are used in the search, but at a lower priority. Thus, portions of the first set of aircraft data can be imported into a goal field 72, a fact field 74, a symptom field 76, and a change field 78. Similarly, data from a cause field 80 and a fix field 82 can be exported into the second set of aircraft data such that the second set of aircraft data defines a cause and fix of the technical issue.

With continuing reference to FIGS. 1-5, it will be appreciated that the present invention provides a computer-implemented aircraft servicing system that improves the efficiency and reliability of aircraft servicing processes. The servicing system includes a knowledge base 24 of reusable solutions, where the knowledge base 24 is derived from prior communications regarding an aircraft 30. A distributed tool maintains the knowledge base 24 in accordance with characterizations of technical issues from individuals in an aircraft manufacturer enterprise. A security model selectively allocates read and write access to the knowledge base 24 between the individuals in the manufacturer enterprise and individuals in an aircraft operator enterprise.

The distributed tool preferably includes an authoring module and a search module. The authoring module enables storage of reusable solutions to the knowledge base 24, where each reusable solution has an assigned access status. The search module enables retrieval of reusable solutions from the knowledge base 24 in accordance with the access statuses. As discussed above, the authoring module prevents field service representatives 38 of the manufacturer enterprise and representatives of the airline 36 from generating reusable solutions.

Thus, the present invention provides unique access to technical support data for the operation and maintenance of commercial airplanes using state-of-the-art search technology. The tool is preferably a World Wide Web application and serves those given access to it by a manufacturer of an aircraft fleet 30. The tool has a security model allowing various levels of access for each of the “solutions” and for each of the “roles,” which are the detailed elements of each solution. The tool works within the internal and external commercial airplanes support processes.

The reusable solution tool provides an effective means to store, retrieve, and deliver technical support data to both internal and external users. The tool is integrated into the existing communication process, allowing data to be retained in a single location with little additional effort. The data can be updated and efficiently retrieved for later use. Since the tool is web-based, the information can be easily shared. The security features of the tool allow a selection of users to appropriately access the same set of data.

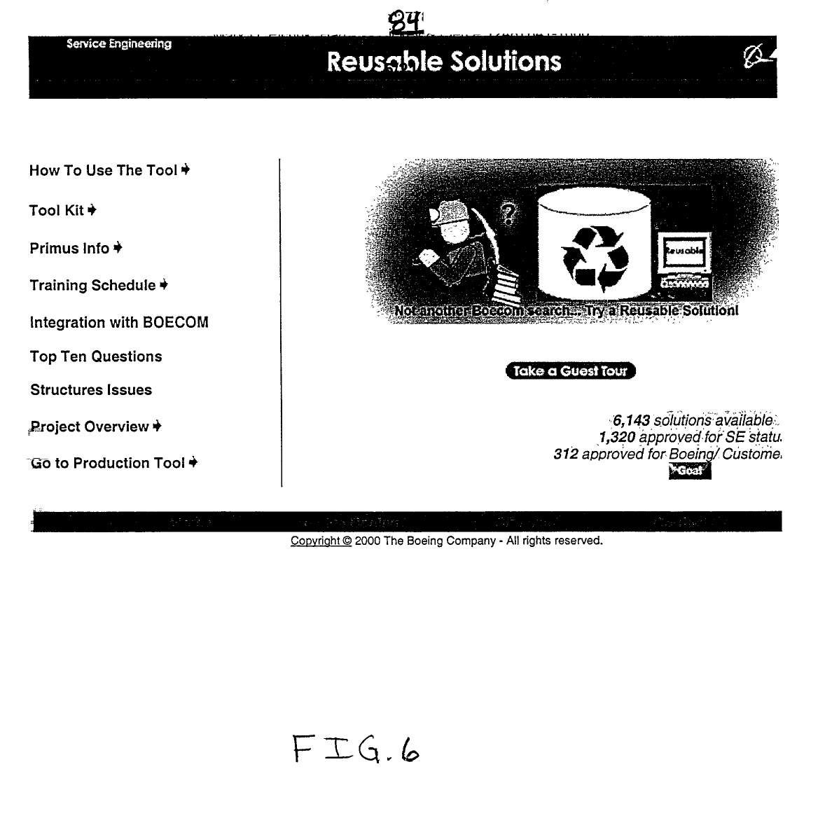

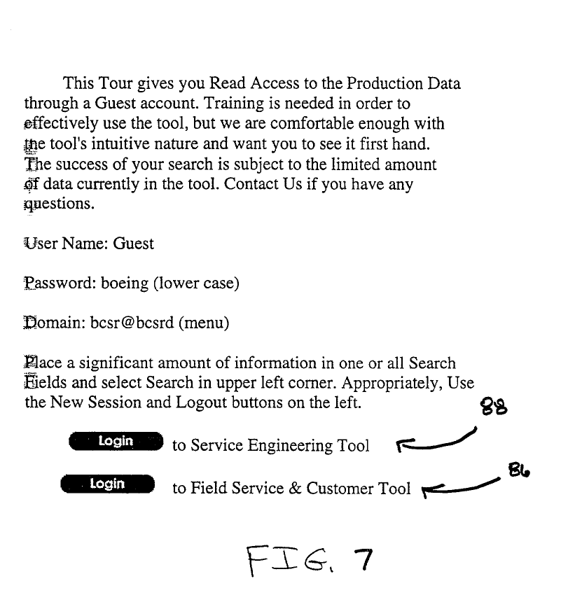

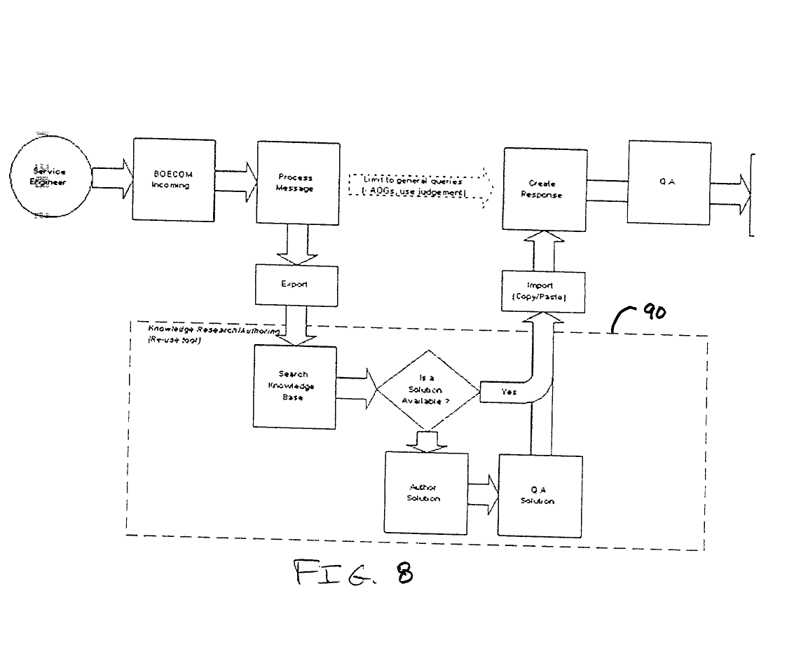

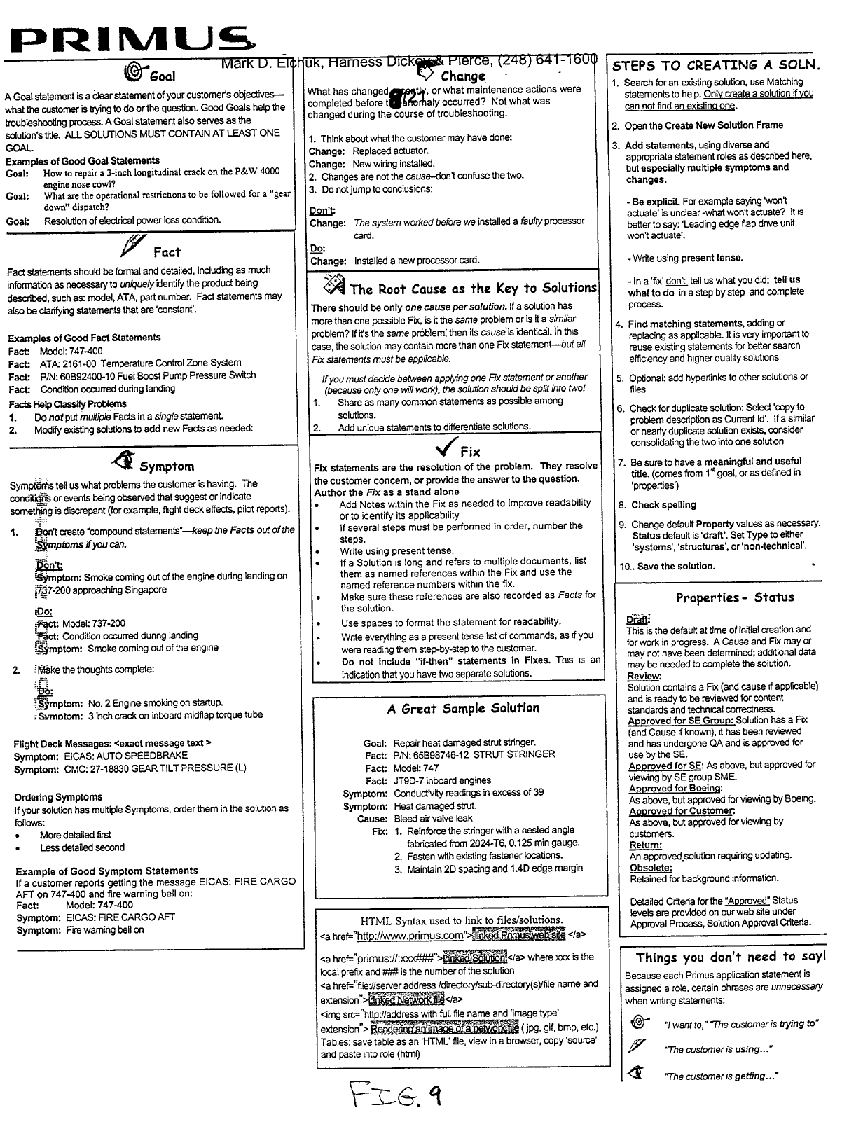

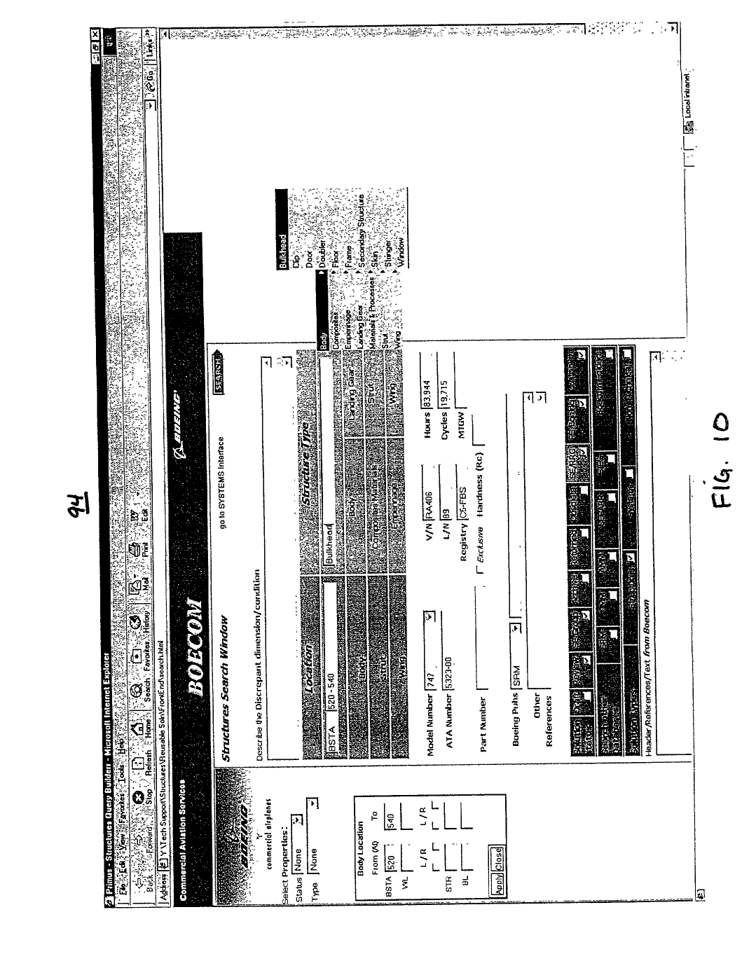

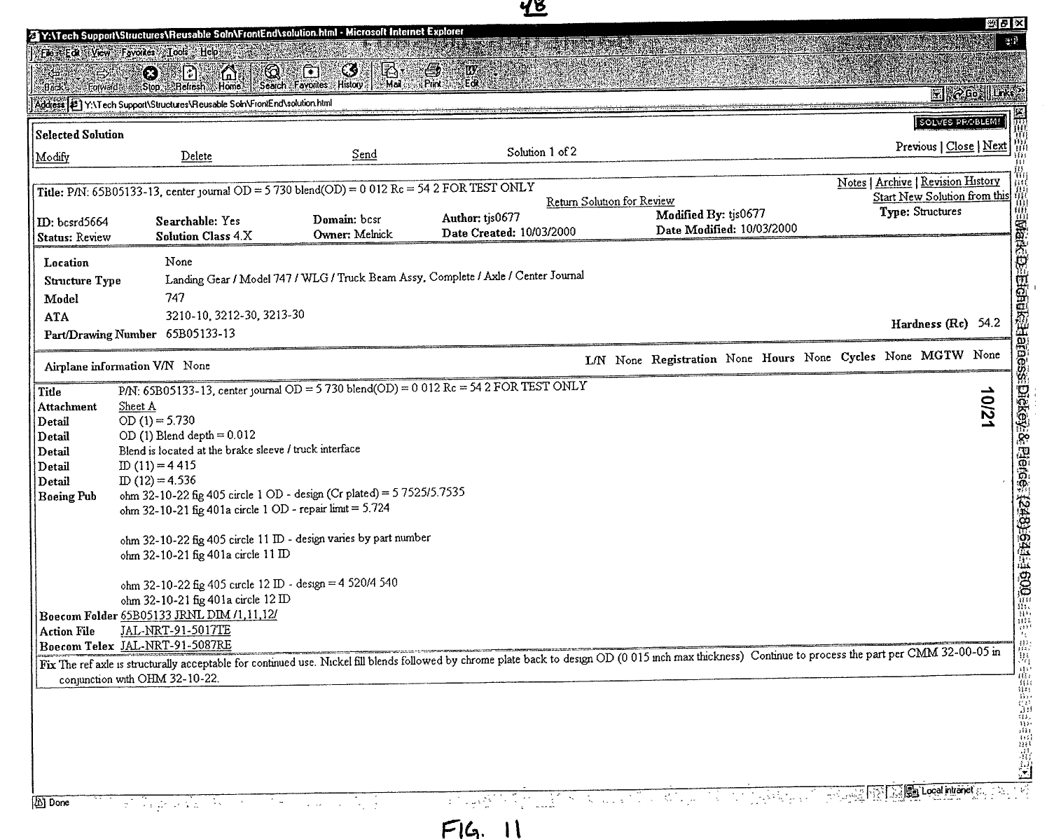

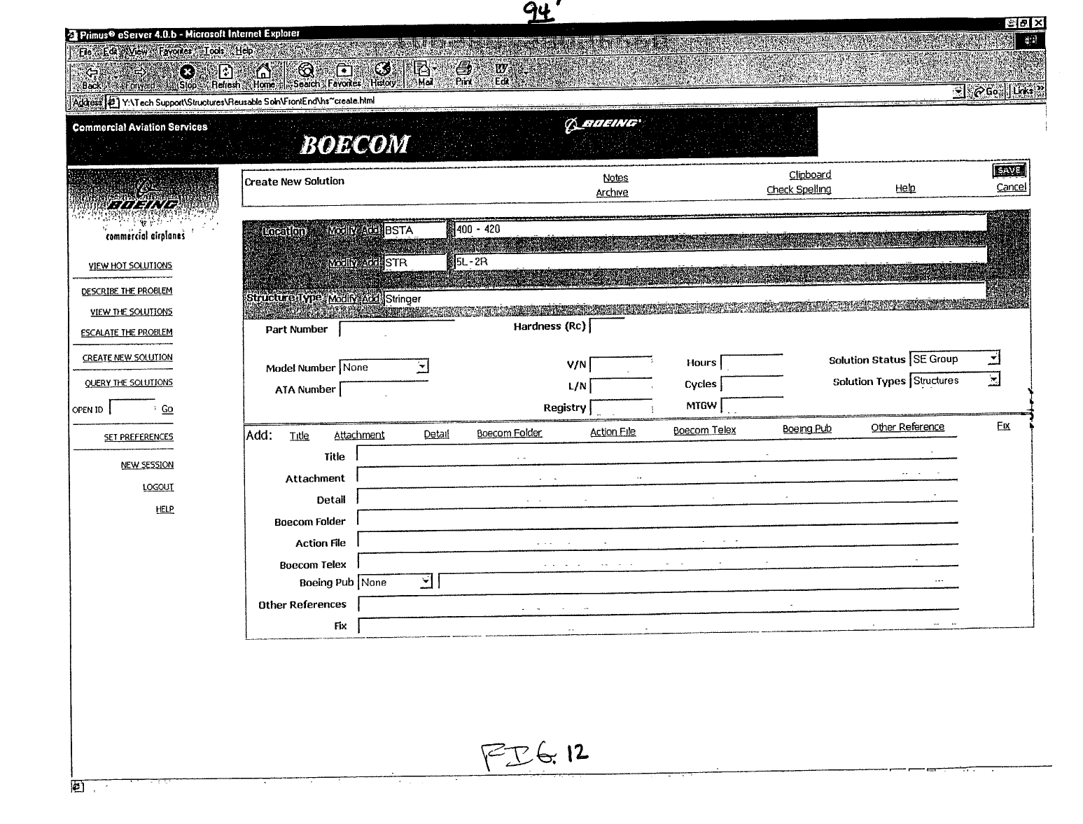

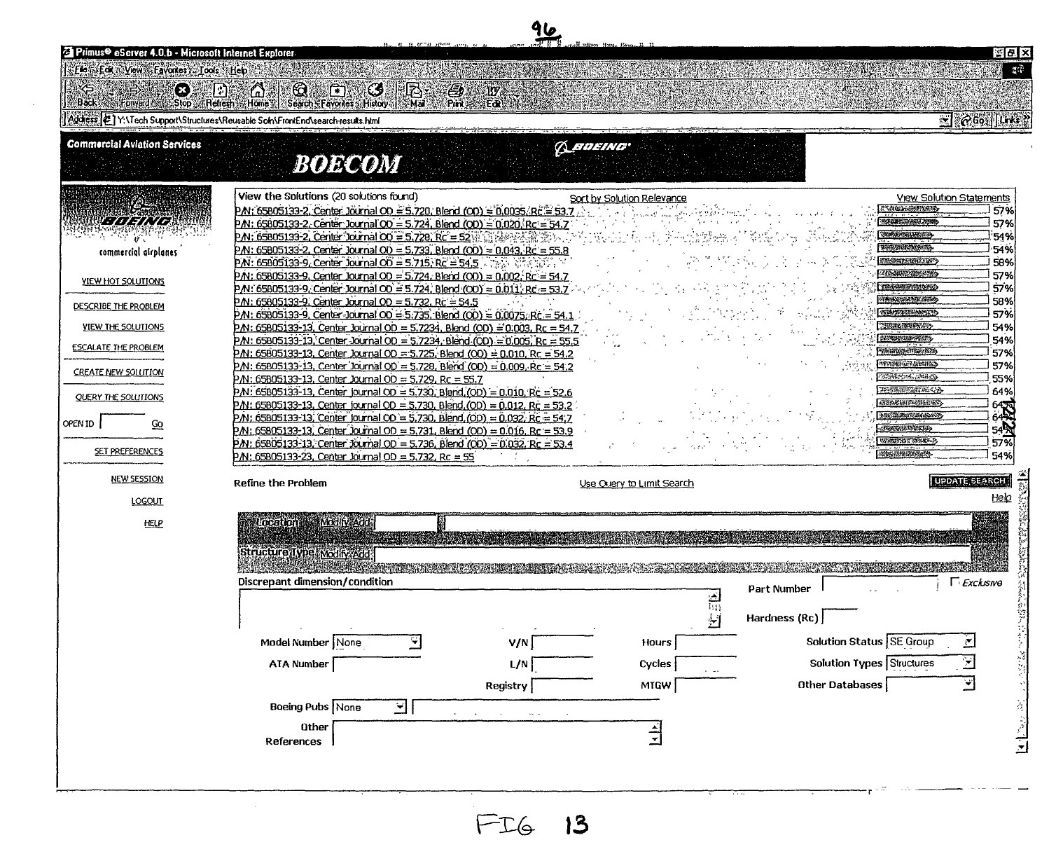

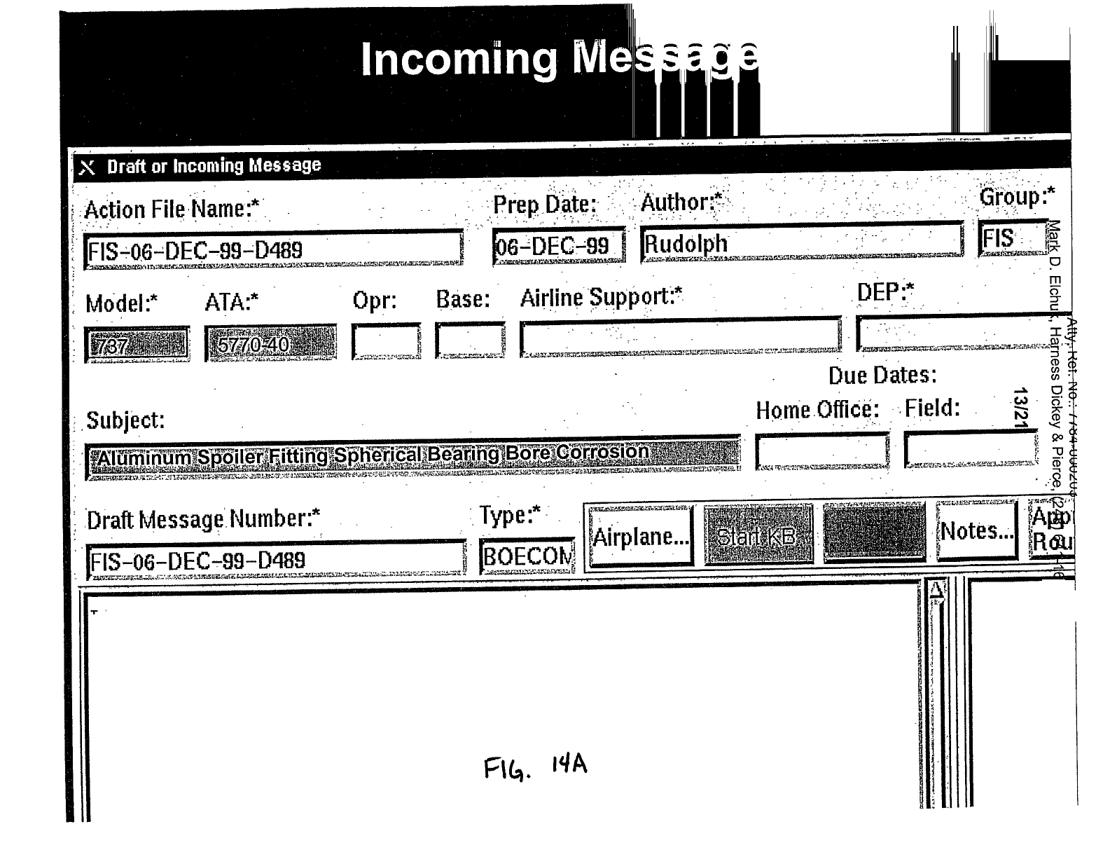

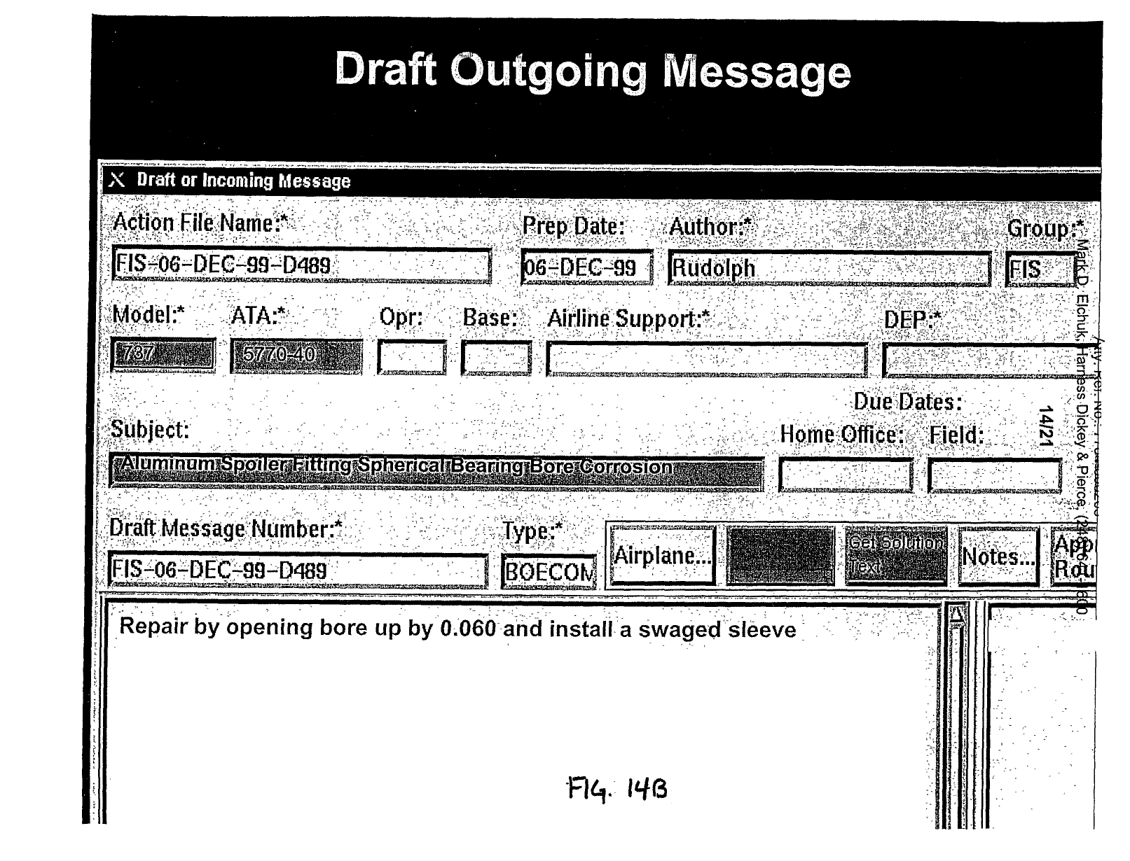

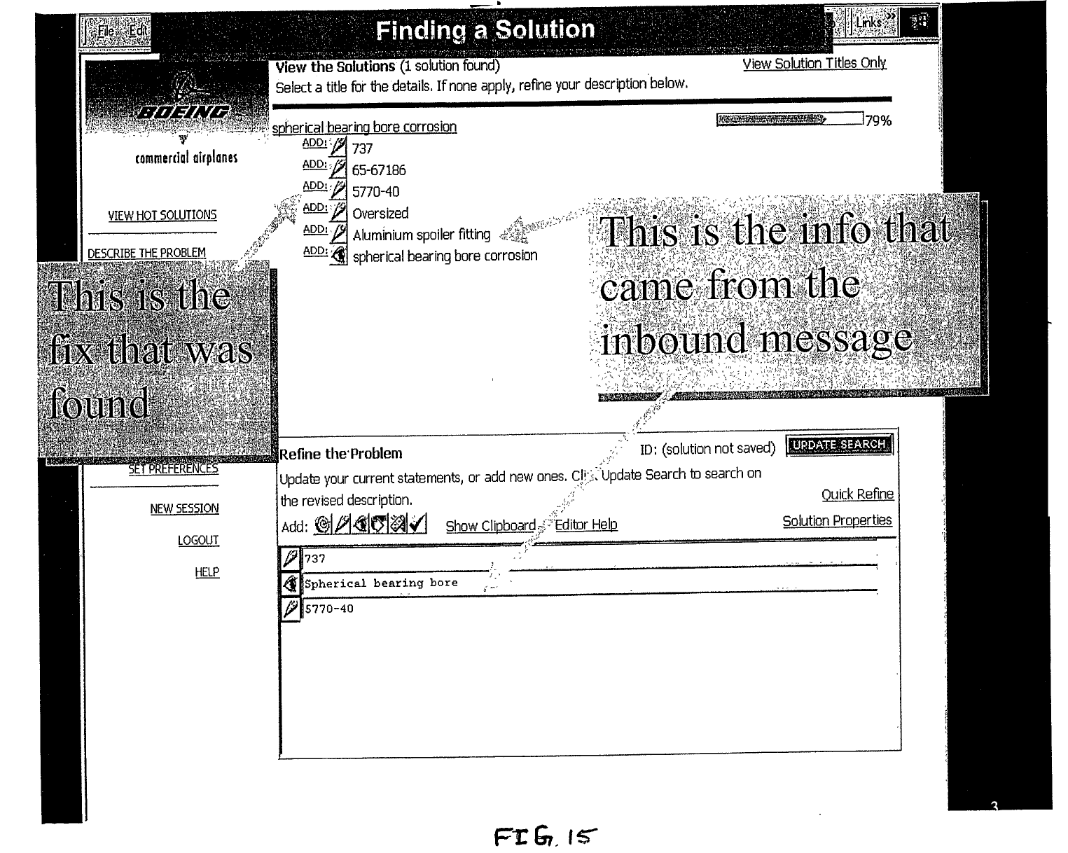

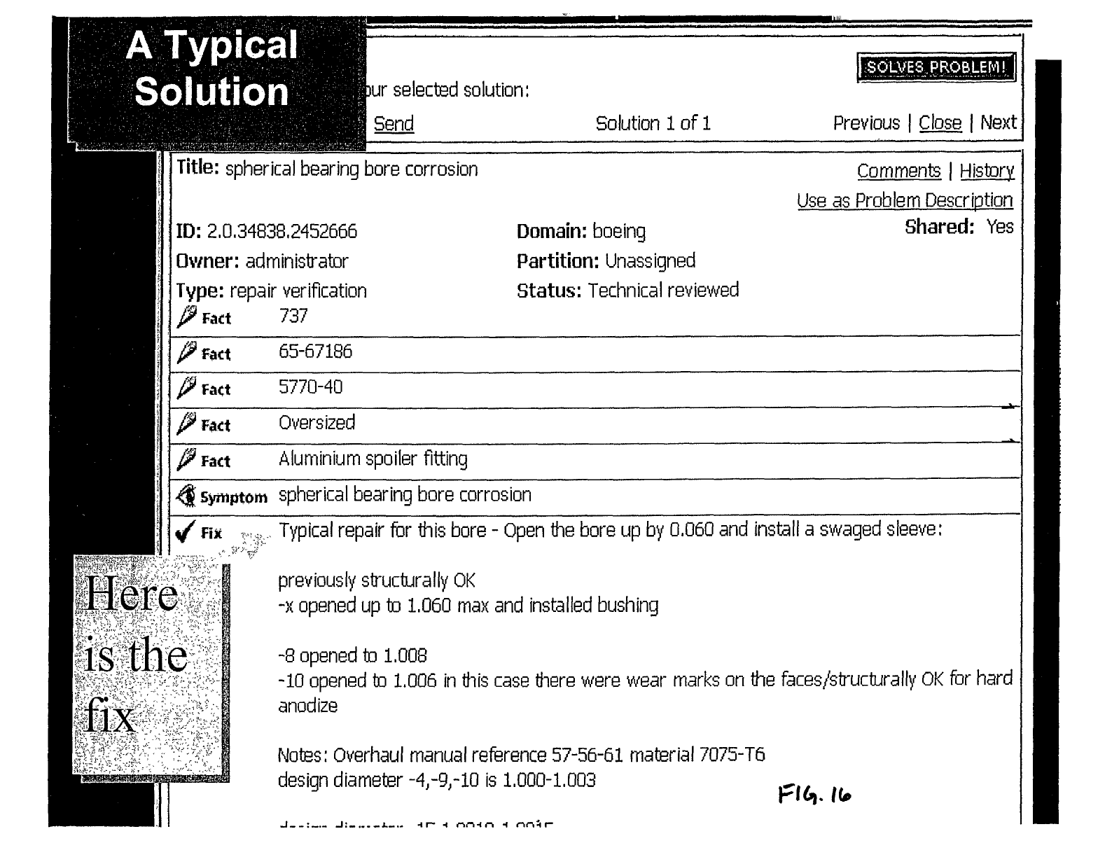

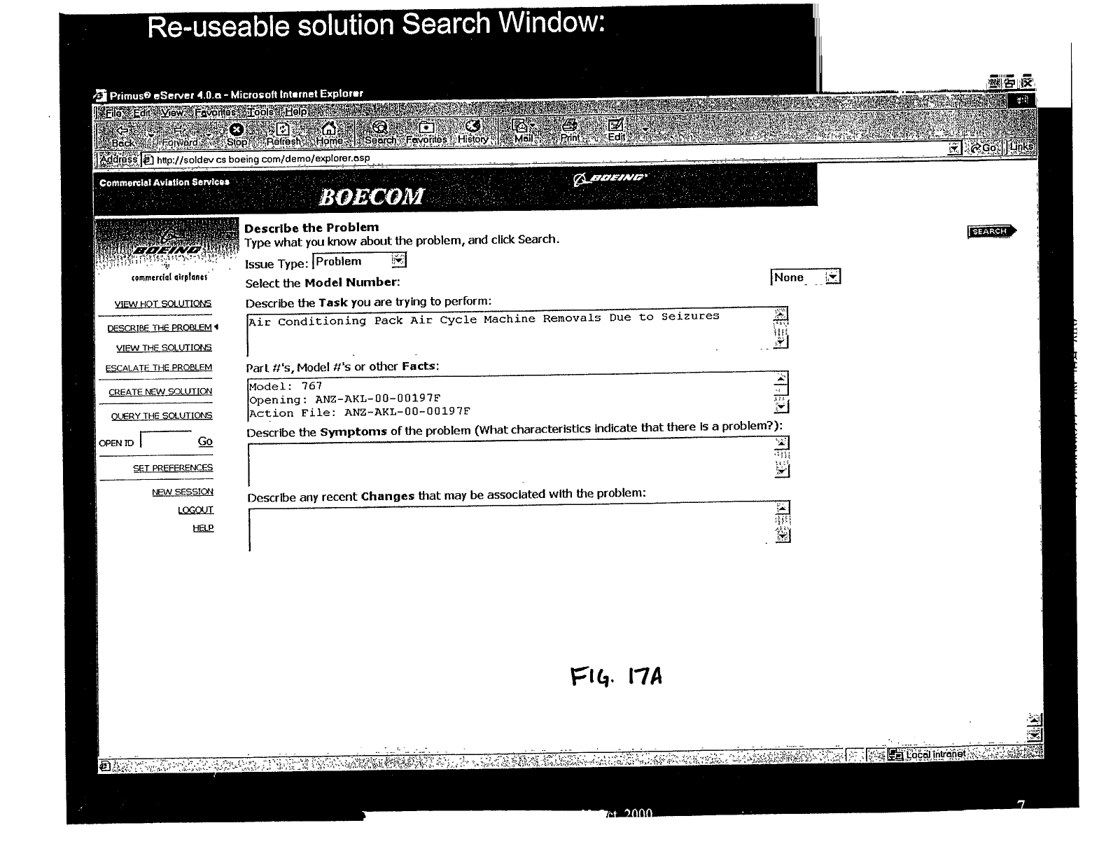

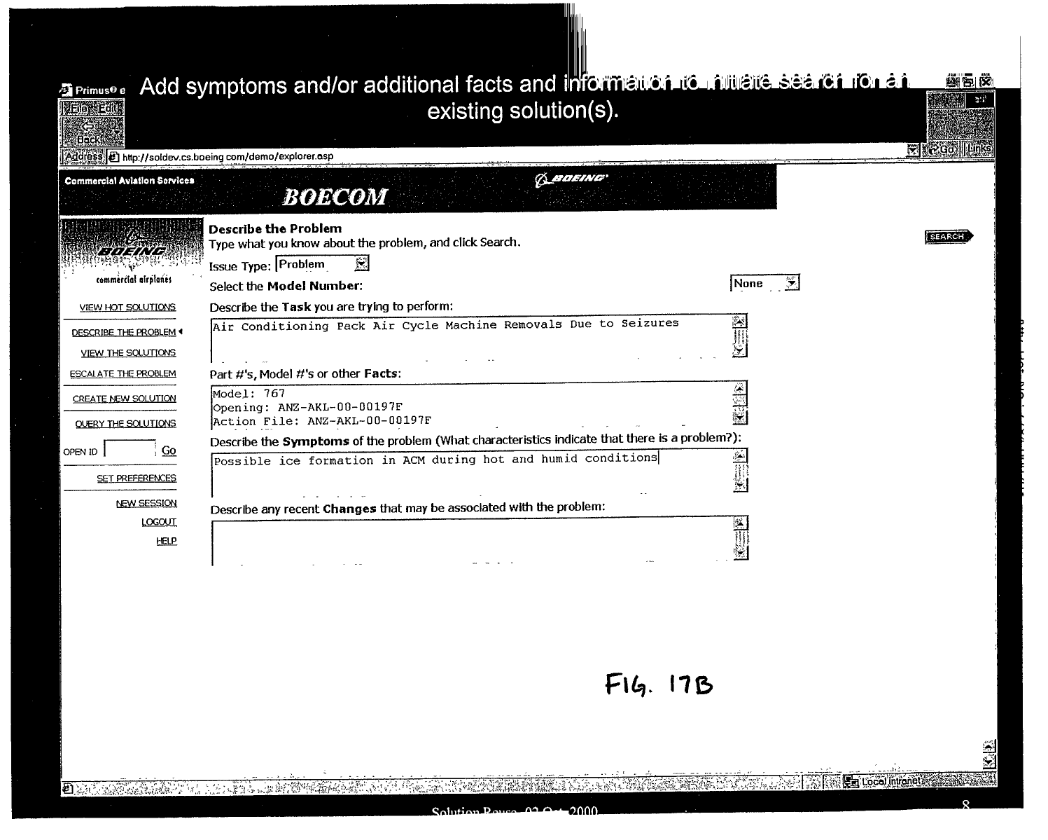

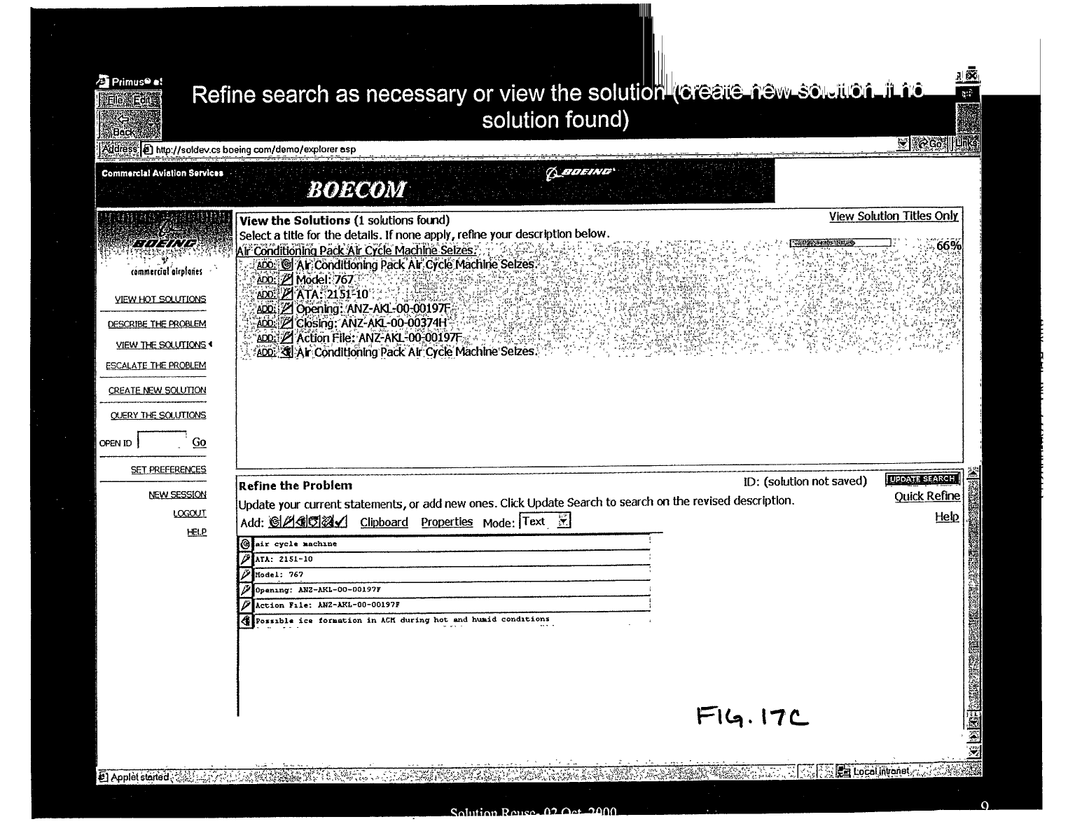

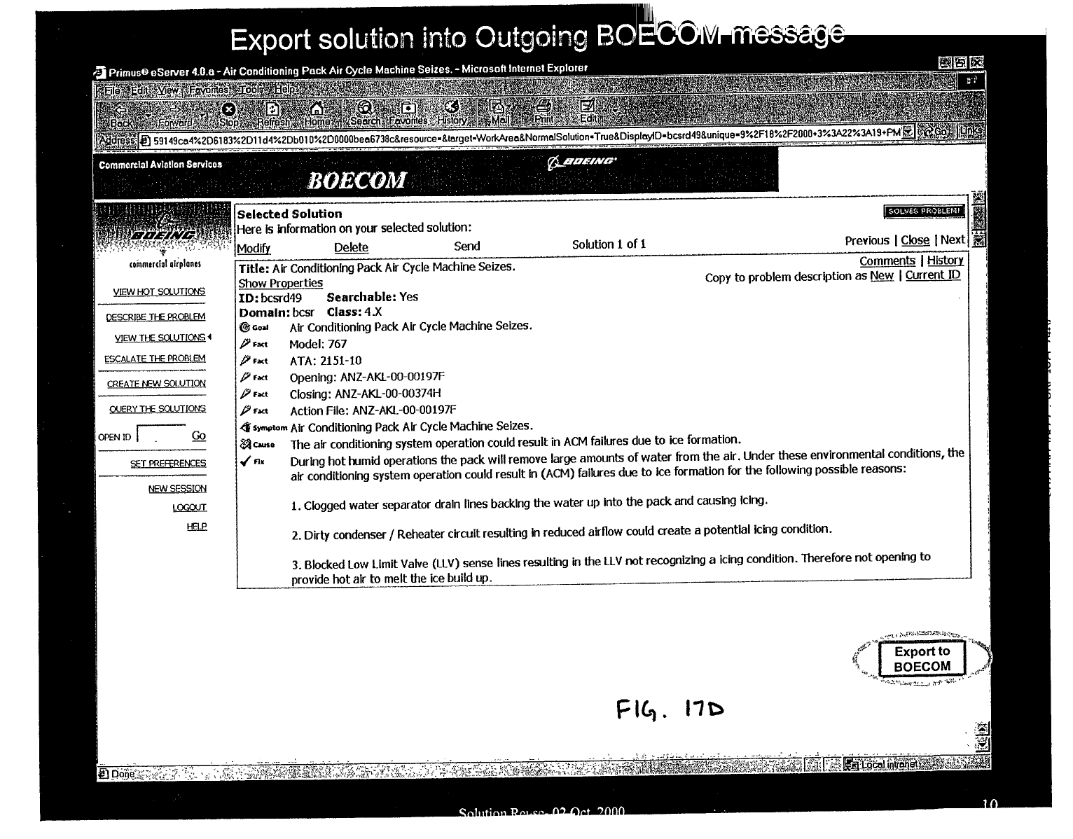

The following is a detailed description of one embodiment of the present invention. First, a user reaches a home page 84, as shown in FIG. 6. The top-level tool is essentially two applications (or tools), as shown in FIG. 7, that access the same set of data. One application is designed for read-only users (Field Service and Customer Tool 86), and the other tool is for subject matter experts who need both the search and authoring capability (Service Engineering Tool 88). The Field Service and Customer Tool 86 is much simpler. The delivery vehicle for field service is through the web. The delivery vehicle to an airline is preferably a web portal.

FIG. 8 demonstrates operation of the tool 90 in relation to the overall servicing process. The tool 90 can be implemented with an appropriate correspondence software package and a commercially available knowledge base software. The presently preferred knowledge base software is available from Primus as indicated by the reference guide 92 shown in FIG. 9. The user interface 94 shown in FIG. 10 illustrates that a user may make various entries in order to solve a problem. For example, a user may make an entry in the Task field, such as “Is it required to check the electrical bonding on the grounding strap of the battery installation housing following the replacement of the battery on a 767 or a 757 airplane,” or Enter in the Symptom field, “I have an oil leak at the IDG, integrated drive generator, input shaft on a 737 airplane.”

FIG. 12 illustrates an alternative user interface 94′. Thus, FIGS. 10 and 12 demonstrate that a user can enter search criteria in one or all of the roles. When selecting the search criteria rich wording, “Rich Words” are words typically used to name or describe technical aspects and actions and taken on the airplane. One of the advantages of the tool is that it can use any phraseology desired. The length of the search criteria is best kept to within 20 words. The program will use the important words and conduct the associative search to establish a list of hits. To use multiple entries for an individual role, the ideas are separated with carriage returns. FIG. 11 illustrates a typical reusable solution 48 stored in the aircraft-specific knowledge base.

As shown in FIGS. 13 and 15, screens 96 and 98 illustrate that following the search, items or solutions resulting from a search will be displayed in a semi-expanded manner, showing the title, goals, facts, and symptoms of each solution. The number of the solutions found is displayed at the top of the screen and is limited to a maximum of 20. A user can use the scroll bar to the right to view all the resulting solutions. The titles can be viewed by selecting the “View Solutions Titles Only” button in the upper right-hand corner. A user can return to the semi-expanded mode by selecting “View Solution Statements”. In both modes you can view the entire solution by double clicking on the title. When viewing the entire solution, an authorized user can select “Modify” to revise the solution if desired.

If a user has completed work regarding aircraft service or in any other form (computer file or paper) and believes that it will be useful to others in the future, it could be saved as a reusable solution (provided the user has authoring access). Both technical and non-technical issues can be placed in the reusable solutions knowledge base. For example, if the user found it difficult to locate a solution, or didn't know whom to call to obtain support, the user has an opportunity to save the experience in a solution so others will benefit from the user's efforts. Simply put, if it has to be done today for one customer (internal or external), you can be sure that it will need to be done in the future.

Thus, a reusable solution is anything that can be used again and is often things kept in a desk drawer, personal data files, or canned responses. Thus, the term “solution” is used in a general sense. A solution is not always a full set of data that will answer a question, but sometimes is a collection of facts and experiences. Reusable solutions are stored in a searching application (the Tool). As already discussed, each solution is made up of the following six elements or roles: goal, fact, symptom, change, cause, and fix. The Solutions vary in length and the number of roles they contain.

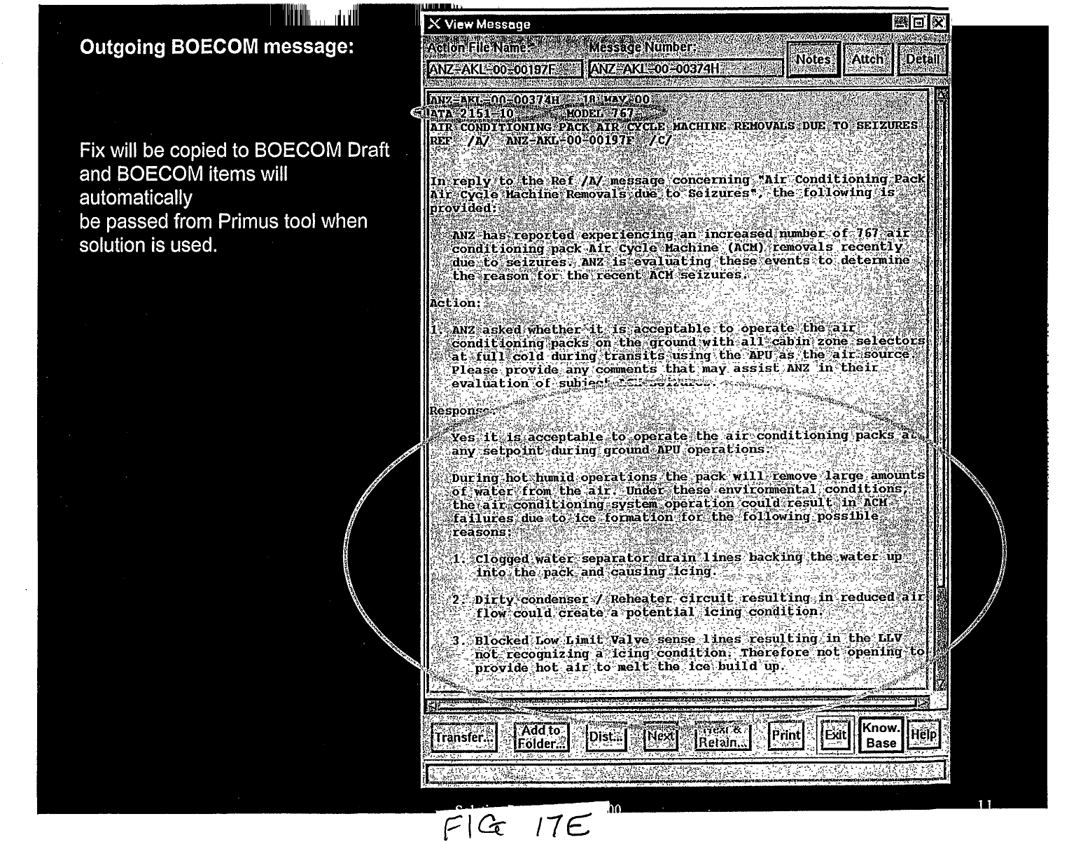

FIGS. 14A and 14B illustrate an incoming message interface 100 and outgoing message interface 102, respectively. An alternative embodiment of a reusable solution is shown generally in FIG. 16 at 48′. FIGS. 17A-17E depict a series of steps used by the tool in solving a problem.

The present invention therefore provides reduced operating costs, lower maintenance costs, reduction of technical delays, reduced response time from service provider to customer, increased quality of responses to customer questions, ability for customers to answer their own questions. The invention reduces the number of customer questions directed to the service provider personnel, reduces time required to prepare a response to a customer, and effectively retains technical experience for effective use in the future. As a result, the service provider has better access to fleet experience data.

Those skilled in the art can now appreciate from the foregoing description that the broad teachings of the present invention can be implemented in a variety of forms. Therefore, while this invention can be described in connection with particular examples thereof, the true scope of the invention should not be so limited since other modifications will become apparent to the skilled practitioner upon a study of the drawings, specification and following claims.

What is claimed is:

1. A computer-implemented method for servicing an aircraft, the method comprising the steps of:
providing a knowledge base of reusable solutions for the aircraft;
receiving an incoming message, where the incoming message characterizes a technical issue relating to the aircraft; and
generating an outgoing message in accordance with one or more of the reusable solutions in the knowledge base in response to the incoming message such that the outgoing message addresses the technical issue.

2. The method of claim 1 further including the steps of:
importing a first set of aircraft data from the incoming message into one or more search roles of an inquiry;
locating a relevant reusable solution in accordance with the inquiry; and
exporting data from one or more solution roles of the relevant reusable solution into a second set of aircraft data in the outgoing message.

3. The method of claim 2 further including the steps of:
searching the knowledge base in accordance with the inquiry;
determining that none of the reusable solutions addresses the technical issue;
verifying that an individual has authoring access to the knowledge base;
receiving authoring input from the individual; and
generating a new reusable solution based on the authoring input.

4. The method of claim 3 further including the steps of:
receiving security input from a service engineer of a manufacturer of the aircraft; and
granting authoring access to the service engineer.

5. The method of claim 3 further including the steps of:
receiving security input from a subject matter expert of the manufacturer of the aircraft; and
granting authoring access to the subject matter expert.

6. The method of claim 3 further including the steps of:
receiving security input from a field service representative of a manufacturer of the aircraft; and
denying authoring access to the field service representative.

7. The method of claim 3 further including the steps of:
receiving security input from an operator representative of an operator of the aircraft; and
denying authoring access to the operator representative.

8. The method of claim 3 further including the step of defining an approval status for the new reusable solution wherein the approval status enables access to the new reusable solution to be limited to a predefined group of individuals.

9. The method of claim 8 further including the step of limiting access to service engineers of a manufacturer of the aircraft.

10. The method of claim 8 further including the step of limiting access to subject matter experts of the manufacturer of the aircraft.

11. The method of claim 2 further including the step of importing a portion of the first set of aircraft data into a goal field of the inquiry such that the goal field defines a goal of the technical issue.

12. The method of claim 2 further including the step of importing a portion of the first set of aircraft data into a fact field of the inquiry such that the fact field defines a fact of the technical issue.

13. The method of claim 2 further including the step of importing a portion of the first set of aircraft data into a symptom field of the inquiry such that the symptom field defines a symptom of the technical issue.

14. The method of claim 2 further including the step of importing a portion of the first set of aircraft data into a change field of the inquiry such that the change field defines a change of the technical issue.

15. The method of claim 2 further including the step of exporting data from a cause field into the second set of aircraft data such that the second set of aircraft data defines a cause of the technical issue.

16. The method of claim 2 further including the step of exporting data from a fix field into the second set of aircraft data such that the second set of aircraft data defines a fix of the technical issue.

17. The method of claim 1 further including the step of maintaining the knowledge base for a plurality of aircraft.

18. The method of claim 17 further including the step of providing reusable solutions for more than two million parts of the plurality of aircraft.

19. A computer-implemented method for updating an aircraft-specific knowledge base, the method comprising the steps of:
determining whether any reusable solutions of the knowledge base addresses a technical issue regarding an aircraft;
verifying whether an individual has authoring access to the knowledge base;
receiving authoring input from the individual when none of the reusable solutions addresses the technical issue; and
generating a new reusable solution based on the authoring input when the individual has authoring access.

20. The method of claim 19 further including the steps of:
receiving security input from a service engineer of a manufacturer of the aircraft; and
granting authoring access to the service engineer.

21. The method of claim 19 further including the steps of:
receiving security input from a subject matter expert of the manufacturer of the aircraft; and
granting authoring access to the subject matter expert.

22. The method of claim 19 further including the steps of:
receiving security input from a field service representative of a manufacturer of the aircraft; and
denying authoring access to the field service representative.

23. The method of claim 19 further including the steps of:
receiving security input from an operator representative of an operator of the aircraft; and
denying authoring access to the operator representative.

24. The method of claim 19 further including the step of defining an approval status for the new reusable solution wherein the approval status enables access to the new reusable solution to be limited to a predefined group of individuals.

25. The method of claim 24 further including the step of limiting access to service engineers of a manufacturer of the aircraft.

26. The method of claim 24 further including the step of limiting access to subject matter experts of the manufacturer of the aircraft.

27. A computer-implemented method for servicing an aircraft, the method comprising the steps of:
receiving an incoming message, where the incoming message characterizes a technical issue with the aircraft;
importing a first set of aircraft data from the incoming message into one or more search roles of an inquiry;
searching a knowledge base of reusable solutions for the aircraft in accordance with the inquiry;
determining whether any reusable solutions of the knowledge base addresses the technical issue;
verifying whether an individual has authoring access to the knowledge base;
receiving authoring input from the individual when none of the reusable solutions addresses the technical issue;
generating a new reusable solution based on the authoring input when the individual has authoring access; and
exporting data from one or more solution roles of the reusable solutions into a second set of aircraft data of an outgoing message.

28. The method of claim 27 further including the step of importing a portion of the first set of aircraft data into a goal field of the inquiry such that the goal field defines a goal of the technical issue.

29. The method of claim 27 further including the step of importing a portion of the first set of aircraft data into a fact field of the inquiry such that the fact field defines a fact of the technical issue.

30. The method of claim 27 further including the step of importing a portion of the first set of aircraft data into a symptom field of the inquiry such that the symptom field defines a symptom of the technical issue.

31. The method of claim 27 further including the step of importing a portion of the first set of aircraft data into a change field of the inquiry such that the change field defines a change of the technical issue.

32. A computer-implemented aircraft servicing system comprising:
a knowledge base of reusable solutions, wherein the knowledge base is derived from prior communications regarding an aircraft;
a distributed tool for maintaining the knowledge base in accordance with characterizations of technical issues from individuals in an aircraft manufacturer enterprise; and
a security model for selectively allocating read and write access to the knowledge base between the individuals in the manufacturer enterprise and individuals in an aircraft operator enterprise.

33. The servicing system of claim 32 wherein the distributed tool includes:
an authoring module enabling storage of reusable solutions to the knowledge base, each reusable solution having an assigned access status; and
a search module enabling retrieval of reusable solutions from the knowledge base in accordance with the access statuses;
said authoring module preventing field service representatives of the manufacturer enterprise and representatives of the operator enterprise from generating reusable solutions.
